(19) United States
(12) Patent Application Publication
(10) Pub. No.: US 2006/0056684 A1
(43) Pub. Date: Mar. 16, 2006

(54) Image processing apparatus, image processing program, image processing method, and imaging apparatus

(76) Inventor: Haruhisa Kurane, Suwa (JP)

Correspondence Address: HARNESS, DICKEY & PIERCE, P.L.C., P.O. BOX 828, BLOOMFIELD HILLS, MI, 48303, US

(21) Appl. No.: 11/222,307

(22) Filed: Sep. 8, 2005

(30) Foreign Application Priority Data
Sep. 10, 2004 (JP) 2004-263363

(51) Int. Cl. G06K 9/00

(52) U.S. Cl. 382/162

(57) ABSTRACT

An image processing apparatus that corrects the gradation scale of brightness values of an image represented by image data produced in a predetermined imaging apparatus. The image processing apparatus including: an acquiring mechanism that acquires information identifying a predetermined location within the image represented by the image data or information concerning brightness values of the predetermined location or both, and also the image data; and a correcting mechanism that corrects the gradation scale of the brightness values of the image represented by the image data using, as a reference value, the average of the brightness values of the predetermined location identified by the acquired information.

### RELATED APPLICATIONS

This application claims priority to Japanese Patent Application No. 2004-263363 filed Sep. 10, 2004 which is hereby expressly incorporated by reference herein in its entirety.

### BACKGROUND OF THE INVENTION

1. Technical Field

The present invention relates to an image processing apparatus, an image processing program, an image processing method and an imaging apparatus which corrects the tone of the brightness values of an image represented by image data taken with a predetermined imaging apparatus.

2. Related Art

Conventionally, an imaging apparatus, such as a digital camera, executes exposure control so that the average of the brightness values of an entire image is 18% of the output dynamic range of the imaging device (namely, the contrast ratio of the image is 18:100) and thereby produce RAW data of high gradation (e.g. 13-bit gradation). Also, the imaging apparatus has been provided as follows. That is, the imaging apparatus makes 18% of the maximum brightness value of an image that the produced RAW data represents (a brightness value corresponding to the contrast ratio of the image) to be the reference value, and uses a predetermined tone curve in which the reference value is the median brightness value of the gradation scale (e.g. 8-bit gradation) that can be represented by a personal computer display, thereby allocating the scale of brightness values of the image that the RAW data shows within the range of tone representable by the display (level compression), and to produce 8-bit image data (e.g. image data of JPEG format) (see JP-A-2000-92379).

In recent years there has been a tendency to file image data in a high gradation format such as 16-bit tone. However, even when image data of high gradation is conventionally produced through exposure control, tonal gradations are only increased and the image contrast ratio is not changed.

In addition, when the contrast ratio of high gradation image data is unknown, level compression cannot be appropriately performed with a conventional tone curve, and therefore white breakup and black breakdown, and accompanying color smearing can be caused. Accordingly, it has been impossible to effectively use the high gradation image data.

### SUMMARY

An advantage of the invention is to provide an image processing apparatus, an image processing program, an image processing method and an imaging apparatus, which allow effective use of high gradation image data.

An image processing apparatus according to a first aspect of the invention corrects the gradation scale of brightness values of an image represented by image data produced in a predetermined imaging apparatus, and includes: an acquiring mechanism that acquires information to identify the predetermined location within the image shown by the image data or information concerning brightness values of the predetermined location or both, and also the image data; and a correcting mechanism that uses, as a reference value, an average of the brightness values of the predetermined location determined by the acquired information, and corrects the gradations of the brightness values of the image shown by the image data. The information concerning the brightness values may include the mean and median brightness values, and the most frequent value.

In an image processing apparatus according to a second aspect of the invention, the predetermined location is a region specified when the image is shot.

In an image processing apparatus according to a third aspect of the invention, the predetermined location is a region previously set in the image.

An image processing program according to a fourth aspect of the invention causes a computer to correct the gradation scale of brightness values of an image shown by image data produced in a predetermined imaging apparatus, and causes the computer to execute: an acquiring function that acquires information to identify the predetermined location within the image shown by the image data or information concerning brightness values of the predetermined location or both, and also the image data; and a correcting function that corrects the gradation scale of the brightness values of the image shown by the image data using, as a reference value, the average of the brightness values of the predetermined location identified by the acquired information.

An image processing method according to a fifth aspect of the invention corrects the gradation scale of brightness values of an image shown by image data produced in a predetermined imaging apparatus, and the method includes the steps of: acquiring information to identify the predetermined location within the image shown by the image data or information concerning brightness values of the predetermined location or both, and also the image data; and correcting the gradation scale of the brightness values of the image shown by the image data using, as a reference value, the average of the brightness values of the predetermined location identified by the acquired information.

According to the first to fifth aspects of the invention, for example, information to identify the location in an image represented by the image data where the subject specified by an operator is located, and information indicating the average of brightness values of the location are acquired, which makes it possible to correct the gradation scale of the brightness values of the image represented by the image data so that the location where the subject specified by the operator is located has an appropriate brightness value. Therefore, for example, even when the brightness value of the subject is high with respect to the dynamic range of the imaging device, the white breakup can be prevented from arising in a bright portion. Also, even when the brightness value of the subject is low, black breakdown can be prevented from arising in a dark portion. Thus, the high gradation that the image data has can be used effectively, unlike the method of correcting the brightness values of the image in which a predetermined fixed brightness value is used as the median value of tone that can be represented by a display.

An imaging apparatus according to a sixth aspect of the invention produces image data of a photographed image, and includes: an exposure-controlling mechanism that performs exposure control so that the average of brightness values of a predetermined photometric region coincides with an exposure reference value set based on a targeted contrast ratio; and an image data-producing mechanism that produces the image data in a correspondence with information identifying the photometric region or the average of brightness values of the photometric region or both.

According to the sixth aspect of the invention, for example, when the contrast ratio of the subject is large, the exposure reference value is set to be smaller and the darkest portion of the subject is used as a photometric region, whereby the ratio of the maximum brightness value to the brightness value of the photometric region can be made larger, and therefore the contrast ratio of the photographed image can also be made larger. In addition, when the contrast ratio of the subject is small, the tonal gradations can be made richer by setting the exposure reference value to an intermediate brightness value. As a result, the high gradation that the image data has can be used effectively, unlike the method of performing exposure control in which a predetermined fixed brightness value is used as the exposure reference value.

### BRIEF DESCRIPTION OF THE DRAWINGS

The invention will be described with reference to the accompanying drawings, wherein like numbers reference like elements, and wherein:

FIG. 1 is a block diagram showing a configuration of a display system according to an embodiment;

FIG. 2 is a block diagram showing a configuration of the digital camera shown in FIG. 1;

FIG. 3 is a block diagram showing a configuration of the imaging section shown in FIG. 2;

FIG. 4 is an illustration to assist in explaining an extended image format file;

FIG. 5 is a block diagram showing a configuration of the television receiver shown in FIG. 1;

FIG. 6 is a block diagram showing a configuration of the level correction calculator shown in FIG. 5;

FIG. 7 is an illustration to assist in explaining a tone curve; and

FIG. 8 is a block diagram to assist in explaining a modification of the invention.

### DETAILED DESCRIPTION

An embodiment of an image processing apparatus according to an aspect of the invention will be described below with reference to the drawings, and will focus on an example in which the invention is applied to a television receiver of a display system capable of taking an arbitrary image and displaying the result of the image-taking.

Specifically, in the display system, a file containing RAW data of a subject that has been imaged and information indicating the photometric region for exposure control is initially produced with a digital camera, and then the file is stored in a recording medium. Subsequently, with the television receiver, the RAW data and information to indicate the photometric region are extracted from the file stored in the recording medium. Further, to correct the gradation scale of brightness values of the image, the average of brightness values for the photometric region identified by the information is used as the median brightness value of the gradation scale representable by the display section, thereby making it possible to make the display section display the image appropriately.

Display System Configuration

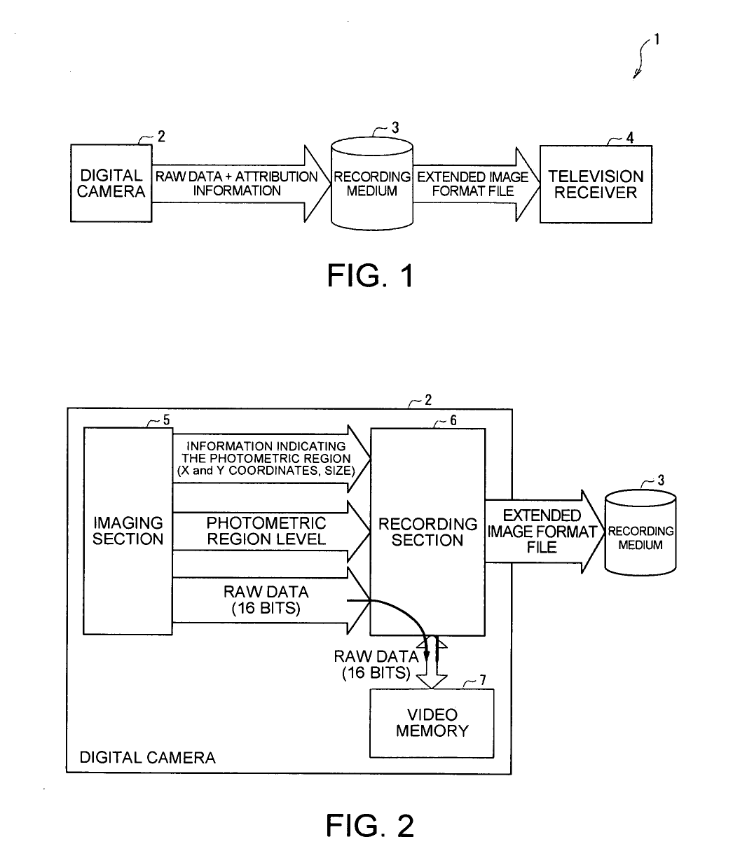

FIG. 1 is a block diagram showing a configuration of the display system according to one embodiment. As shown in FIG. 1, the display system 1 includes a digital camera 2 according to the invention, a recording medium 3 and a television receiver 4.

The digital camera 2 includes an imaging section 5, a recording section 6 and a video memory 7, as shown in FIG. 2.

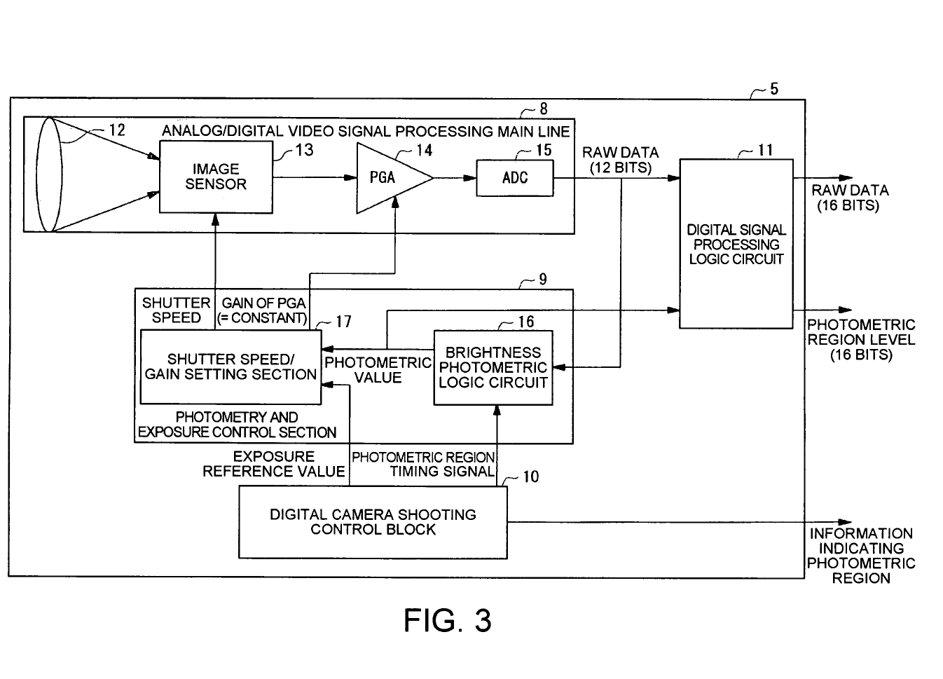

Further, the imaging section 5 includes an analog/digital video signal processing main line 8, a photometry and exposure control section 9, a digital camera shooting control block 10 and a digital signal processing logic circuit 11, as shown in FIG. 3.

In the analog/digital video signal processing main line 8, light from the subject is gathered by a lens 12, and the light is converted into an electric signal by an imager sensor 13. Subsequently, in the analog/digital video signal processing main line 8, PGA 14 amplifies the electric signal resulting from the conversion, and the resultant electric signal is digitalized by ADC (Analog-to-Digital Converter) 15. Thus, 12-bit (4096 step tones) image data (i.e. RAW data, which contains information to indicate the brightness value of each pixel) is produced. Then, the analog/digital video signal processing main line 8 outputs the produced 12-bit RAW data to the photometry and exposure control section 9 and the digital signal processing logic circuit 11. The image sensor 13 used in the embodiment has a dynamic range of 72 db or more (equivalent to 12 bits). In other words, the image sensor 13 has four times or greater dynamic range than a standard image sensor having a dynamic range of e.g. 60 db (10 bits).

Also, in the analog/digital video signal processing main line 8, when a predetermined photographing operation is performed, the image sensor 13 is subjected to exposure control at a shutter speed set by a shutter speed/gain setting section 17 in the photometry and exposure control section 9 (to be described later) and then RAW data of a subject is produced.

Further, in the photometry and exposure control section 9, a certain region of a subject specified by an operator within an image shown by RAW data output from the ADC 15 in the analog/digital video signal processing main line 8 is first detected and set as the “photometric region” based on a photometric region timing signal (to be described later) output from the digital camera shooting control block 10. The average of brightness values (also, hereinafter referred to as “photometric value”) in the photometric region is detected by a brightness photometric logic circuit 16. Then, the detected photometric value is output to the digital signal processing logic circuit 11 and the shutter speed/gain setting section 17. Subsequently, the shutter speed of the image sensor 13 is set with the shutter speed/gain setting section 17 so that the output photometric value coincides with an exposure reference value (to be described later), which is output from the digital camera shooting control block 10. The methods to detect the region of the subject specified by an operator include detecting the region that the operator was watching closely at the time of photographing the subject. Further, while the method of detecting the region of the subject specified by the operator so that the average of brightness values of the region can be used as a photometric value has been shown, the invention is not so limited. For example, when the photometric scheme has been predetermined to be measurement of central focus, there can be cited a method of detecting the average of brightness values at a central pixel region, and directly setting this detected value as the photometric value without detecting the region that the operator is watching.

In addition, the digital camera shooting control block 10 outputs a photometric region timing signal to indicate the photometric region within an image shown by RAW data output from the ADC 15 to the brightness photometric logic circuit 16. Also, the digital camera shooting control block 10 outputs an exposure reference value corresponding to the targeted contrast ratio to the shutter speed/gain setting section 17. Specifically, in the operation to input the targeted contrast ratio, when an operation to direct that the contrast ratio is small is performed, an exposure reference value that makes the brightness of the subject 18% of the dynamic range of the image sensor 13 is output. Also, when an operation to direct that the intended contrast ratio is large is performed, an exposure reference value that makes the brightness of the subject 5% of the dynamic range of the image sensor 13 is output. Thus, when a subject is photographed with a large contrast ratio, an image with a dynamic range approximately four (18/5) times larger than that in the case where a subject is photographed with a small contrast ratio can be obtained. In addition, the image sensor 13 used in the embodiment has a dynamic range four times (72 db) as large as that of a standard image sensor (60 db) and as such, even when the brightness value of a subject is made less than or equal to 5% of the dynamic range, the same gradation as that which the standard image sensor provides is maintained. Incidentally, altering the exposure reference value appropriately depending on the contrast ratio of the subject allows the image quality to be made higher. Further, the digital camera shooting control block 10 outputs information to indicate the photometric region within the image (such as information to indicate the center of the pixel region corresponding to the photometric region, and information to indicate the size of the photometric region) to the recording section 6.

Moreover, the digital signal processing logic circuit 11 performs digital signal processes on 12-bit RAW data output from the ADC 15 (processes to reduce the individual differences between digital cameras 2, e.g. a process to correct shading caused by the characteristics of the lens 12, and a process to eliminate noises) to produce 16-bit RAW data, and then outputs the resultant 16-bit RAW data to the recording section 6. Also, the digital signal processing logic circuit 11 converts the photometric value output from the brightness photometric logic circuit 16 to 16 bits, and outputs the resultant value as a photometric region level to the recording section 6.

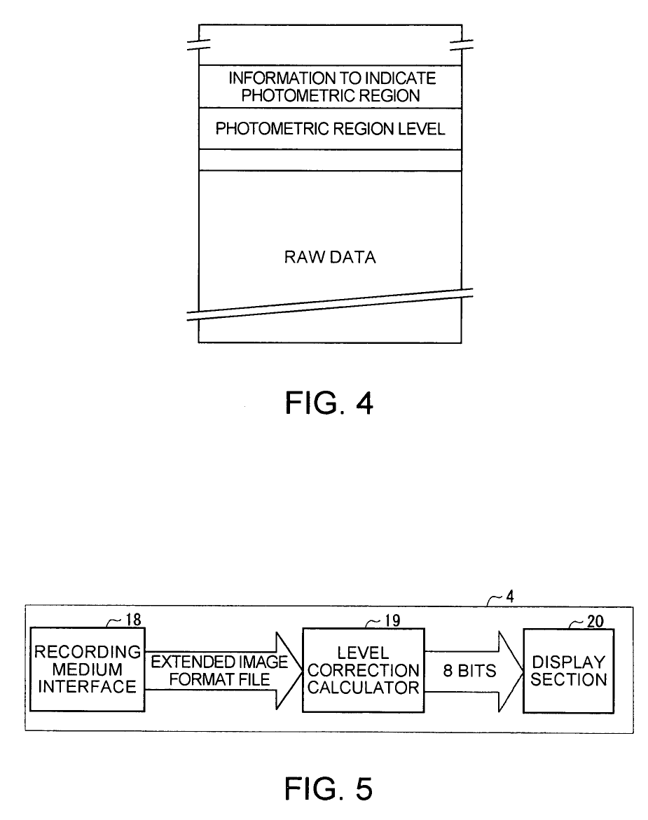

On the other hand, the recording section 6 stores 16-bit RAW data output from the imaging section 5 (the digital camera shooting control block 10 and digital signal processing logic circuit 11) in the video memory 7, as shown in FIG. 2. When RAW data that represents one frame has been stored in the video memory 7, the recording section 6 collects the RAW data together with information output from the digital signal processing logic circuit 11 which indicates the photometric region average level and information output from the digital camera shooting control block 10 which identifies the photometric region, and does not compress them, producing a single file (hereinafter referred to as “extended image format file”) as shown in FIG. 4, and stores the file in the recording medium 3.

The recording medium 3 is formed so that data can be transmitted from the recording medium to the television receiver 4 and received by the recording medium from the digital camera 2 (recording medium interface 18). When the digital camera 2 (recording section 6) outputs a writing request, an extended image format file produced in the digital camera 2 is stored in the recording medium 3. Also, when the television receiver 4 outputs a read-out request, the recording medium 3 outputs an extended image format file stored in the recording medium 3 to the television receiver 4.

The television receiver 4 includes a recording medium interface 18, a level correction calculator 19 and a display section 20, as shown in FIG. 5.

The recording medium interface 18 is arranged so that the recording medium 3 which stores extended image format files produced in the digital camera 2 can be removed from and attached to the digital camera. When the recording medium 3 is attached so that data can be transmitted and received, the recording medium interface 18 reads out an extended image format file from the attached recording medium 3 and outputs the file to the level correction calculator 19.

The level correction calculator 19 has a microcomputer and its peripheral components. When an extended image format file is output through the recording medium interface 18, the level correction calculator 19 first extracts information to identify the photometric region for exposure control and extracts the RAW data from the output extended image format file. In other words, in the embodiment, the television receiver 4 can recognize the photometric region and therefore can display the region with high image quality, specifically with good gradation. Now, a method of producing a tone curve in the level correction calculator 19 for display with such high image quality will be described below. In producing a tone curve, it does not matter what the characteristics of the curve are as long as the pixel values of the photometric region are utilized.

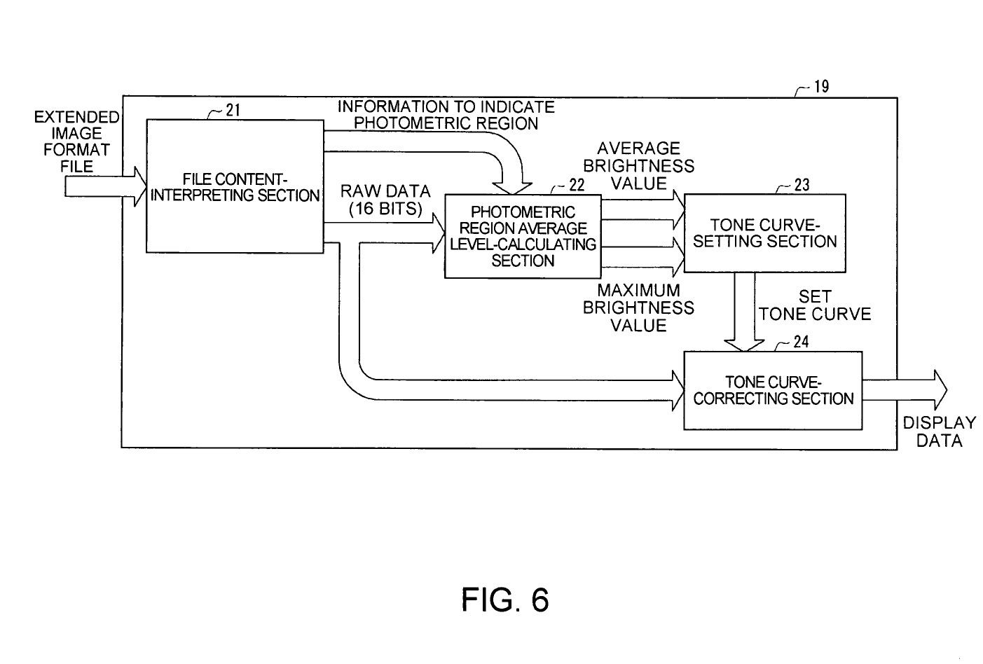

The level correction calculator 19 determines the average of brightness values of the photometric region based on the extracted information. Subsequently, a tone curve is set, in which the average of brightness values thus determined is used as the median brightness value of the gradation scale which can be represented by the display section 20. The gradation scale of the image represented by the RAW data is corrected using the set tone curve. The result of the correction is output to the display section 20. Specifically, the level correction calculator 19 is constituted by dedicated pieces of hardware and a software form for a microcomputer, as shown in FIG. 6. More specifically, the level correction processor includes a file content-interpreting section 21, a photometric region average level-calculating section 22, a tone curve-setting section 23 and a tone curve-correcting section 24.

The file content-interpreting section 21 extracts information indicating the photometric region and RAW data from the extended image format file which is input through the recording medium interface 18. Then, the file content-interpreting section 21 outputs the information indicating the photometric region to the photometric region average level-calculating section 22, and the RAW data to the photometric region average level-calculating section 22 and the tone curve-correcting section 24.

Based on the information indicating the photometric region and the RAW data which are output from the file content-interpreting section 21, the photometric region average level-calculating section 22 calculates the average of brightness values of the pixel region corresponding to the photometric region within the image represented by the RAW data, and the maximum brightness value in the entire image. The calculated average and maximum brightness value are output to the tone curve-setting section 23.

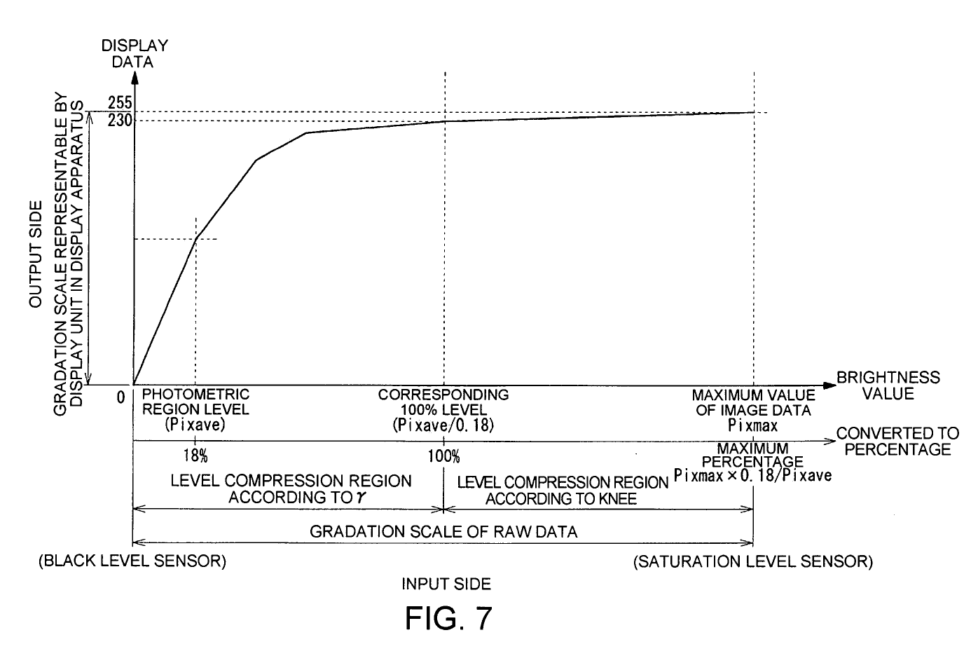

As shown in FIG. 7, the tone curve-setting section 23 produces a tone curve that enables the correction of an image represented by the RAW data of 16 bits (65536-gradations) to 8 bits (256-gradations) based on the maximum brightness value and average output from the photometric region average level-calculating section 22, in which the average brightness value is used as the input-side reference value (e.g. 18% on a percentage basis) and the reference value is used as the median value with respect to the maximum value of the output side (maximum tone that can be represented by a later-described display unit in the display section 20, e.g. 255). The tone curve thus produced is set as the tone curve used by the tone curve-correcting section 24. The process is implemented by the software form for the microcomputer. Particularly, the tone curve Diout is set based on the average brightness value Pixave and maximum brightness value Pixmax, both output from the photometric region average level-calculating section 22, and the brightness value Pixin of each pixel of the image represented by the 16-bit RAW data output from the file content-interpreting section 21, as shown by the following expressions (1) and (2).

In the case where Pixin is less than or equal to Pix100% (=Pixave/0.18),
Diout=Pixin×0.18/Pixave (1).

In the case where Pixin is larger than Pix100%,
Piout=Cknee×(Pixin−Pix100%)+DiOut100% (2)
Cknee=25/(Pixmax−Pix100%),
where Diout100% is Diout at Pix100% in the expression (1).

Also, the tone curve-correcting section 24 uses the tone curve set by the tone curve-setting section 23 to correct the gradation scale of brightness values of the image represented by the image data output from the file content-interpreting section 21 from 16 bits to 8 bits, and outputs the corrected image data to the display section 20.

Further, the display section 20 includes a display unit (not shown) that can represent an image represented by image data of 8 bits (256 gradations) in addition to an image received through a television broadcast, as shown in FIG. 5. When the level correction calculator 19 (tone curve-correcting section 24) outputs 8-bit image data, the display section 20 makes the display unit (not shown) display the output image data with all the tones that can be represented by the display unit (not shown). While an example where the gradation scale of the display unit (not shown) is 8 bits has been shown in the above embodiment, the invention is not so limited. The gradation scale may be, for example, 10 bits, as well as 8 bits.

Specific Work of Television Receiver

Now, the work of the display system 1 in the embodiment will be described in detail based on specific situations.

In the first case where a subject with a large contrast ratio is photographed, an operation making the target contrast ratio large is carried out. Then, as shown in FIG. 1, the digital camera 2 executes exposure control that for example makes the brightness value of the subject 5% of the dynamic range of the image sensor 13 and produces 16-bit RAW data that can represent a brightness value up to about twenty times the brightness value of the subject. An extended image format file containing the RAW data and information indicating the photometric region for exposure and correction control is stored in the recording medium 3. Next, the recording medium 3 is put in the recording medium interface 18 of the television receiver 4. Then, an extended image format file is read out through the recording medium interface 18 from the recording medium 3 put therein, as shown in FIG. 5, and the extended image format file is output to the file content-interpreting section 21 in the level correction calculator 19.

Then, as shown in FIG. 6, the file content-interpreting section 21 extracts information indicating the photometric region and RAW data from an extended image format file output through the recording medium interface 18. The extracted information indicating the photometric region is output to the photometric region average level-calculating section 22. The RAW data is output to the photometric region average level-calculating section 22 and the tone curve-correcting section 24. Based on the output information indicating the photometric region and RAW data, the photometric region average level-calculating section 22 calculates the average of brightness values of the pixel region corresponding to the photometric region within the image represented by the RAW data, and the maximum brightness of the entire image. The calculated average and maximum brightness values are output to the tone curve-setting section 23.

Based on the output maximum brightness value and average, the tone curve-setting section 23 produces a tone curve that enables the correction of the 16-bit RAW data to 8 bits, in which the average brightness value is used as the input-side reference value, and this reference value is used as the median value with respect to the maximum value of the output side. The resultant tone curve is set as the tone curve used by the tone curve-correcting section 24. Further, the tone curve-correcting section 24 uses the set tone curve to correct the gradation scale of brightness values of the image represented by the RAW data from 16 bits to 8 bits. The corrected RAW data is output to the display section 20. The display section 20 makes the display unit (not shown) display the output RAW data with all the tones that can be represented by the display unit (not shown).

As described above, the digital camera 2 in the embodiment is formed so as to output 16-bit RAW data, and as such, the digital camera 2 has a sufficient ability to express gradations. Also, the digital camera is arranged so that a photometric region is recorded, which enables shooting with a reference level of 5% when a subject needs a high contrast ratio, and therefore enables shooting of areas with up to twenty times the luminosity of the photometric region. Thus, it becomes possible to shoot an image with a wider tonal gradation and no white breakup, and therefore the latitude can be widened. At the time of shooting an image, a photometric region or a photometric region level is recorded, and the image can be displayed as long as that value is given to the display portion. As such, the exposure reference value for exposure control may be an arbitrary value.

Incidentally, in the case of the method of setting (fixing) the brightness of the photometric region at e.g. 18% of the dynamic range of the image sensor 13, the maximum luminosity of an area being shot is about five (100/18) times the luminosity of the photometric region, and thus the latitude may not be able to be widened.

Further, the television receiver 4 in the embodiment is arranged so that information indicating the photometric region for exposure control, i.e. information to determine the region where the subject specified by the operator is located within an image represented by RAW data, is acquired, and the gradation scale of brightness values of the image represented by the RAW data is corrected so as to make the brightness value of that region proper. Thus, it becomes possible to display an image reflecting the intention of an operator, and therefore the image quality can be made higher. Further, RAW data stored in the form of an extended image format file has a 16-bit gradation scale, and the recording of the photometric region in the embodiment enables shooting and recording an image with higher contrast ratio, which make it possible to output an image with a high image quality and no white breakup. In other words, unlike the method of correcting the brightness values of the image in which a predetermined fixed brightness value is used as median tone in the gradation scale that can be represented by the display unit, the high gradation that the RAW data has can be used effectively.

As described above, the television receiver 4 shown in FIGS. 1 and 5, the level correction calculator 19 in FIG. 5 and the file content-interpreting section 21 in FIG. 6 constitute the acquiring mechanism in the claims herein. Likewise, the television receiver 4 in FIGS. 1 and 5, the level correction calculator 19 in FIG. 5, and the photometric region average level-calculating section 22, tone curve-setting section 23 and tone curve-correcting section 24 in FIG. 6 constitute the correcting mechanism. The file content-interpreting section 21 in FIG. 6 carries out the acquiring function. The photometric region average level-calculating section 22, tone curve-setting section 23 and tone curve-correcting section 24 in FIG. 6 carry out the correcting function. The imaging section 5 in FIG. 2, and the photometry and exposure control section 9 and digital camera shooting control block 10 in FIG. 3 constitute an exposure-controlling mechanism. The imaging section 5 and recording section 6 in FIG. 2, and the analog/digital video signal processing main line 8, digital camera shooting control block 10 and digital signal processing logic circuit 11 in FIG. 3 constitute an image data-producing mechanism.

The image processing apparatus, image processing program, image processing method and imaging apparatus according to aspects of the invention are not limited by the details of the above embodiment. They may be changed appropriately within a scope that utilizes the ideas of the invention.

For example, the above embodiment describes an example in which information indicating the photometric region for exposure control and RAW data are collected in an extended image format file, i.e. a specific format file. However, the invention is not so limited. For instance, EXIF—a standard of JEITA (Japan Electronics and Information Technology Industries Association), and the TIFF standard that has been used generally may be utilized to add information indicating the photometric region to RAW data. Further, for example, an additional file in one-to-one correspondence with the RAW data may be produced independently of the RAW data to record the information indicating the photometric region in the additional file. In this case, the information indicating the photometric region may contain X and Y coordinates of the photometric region and the size of the photometric region. In the case where the decision that the photometric scheme for the digital camera 2 is measurement of central focus, the following may be added to the information indicating the photometric region: the radius of the photometric region and a weighting coefficient for the radius.

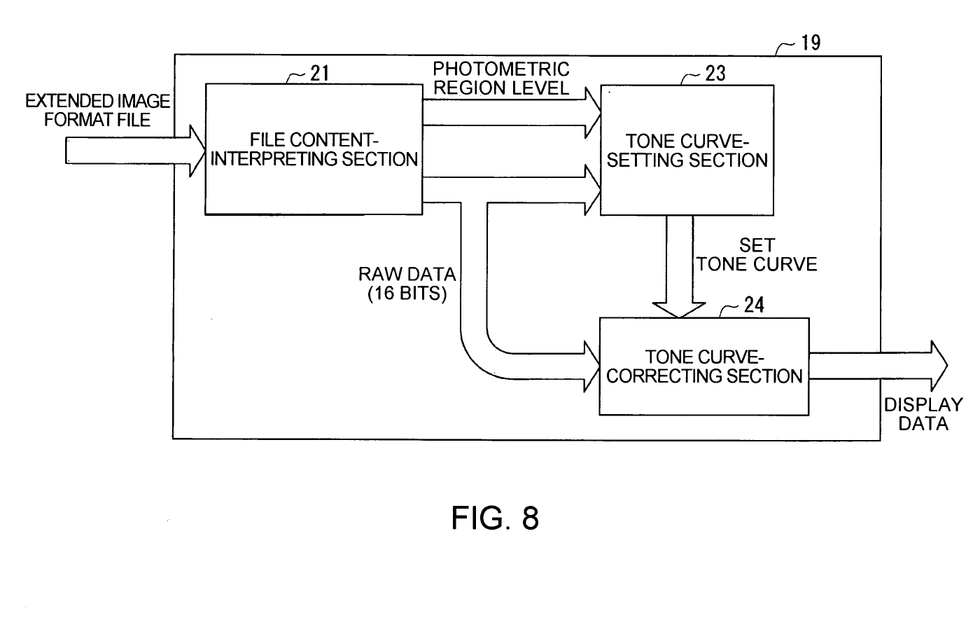

The embodiment gives an example in which information indicating the photometric region for exposure control and RAW data are extracted from an extended image format file, the average of brightness values of the pixel region corresponding to the photometric region within the image represented by the extracted RAW data is calculated, and a tone curve in which the calculated average brightness value is used as an input-side reference value is set. However, the invention is not so limited. For example, as shown in FIG. 8, the photometric region level, namely, the average of brightness values, may be extracted from an extended image format file, and a tone curve may be set in which the extracted average brightness value is used as the input-side reference value.

What is claimed is:

1. An image processing apparatus that corrects a gradation scale of brightness values of an image represented by image data produced in a predetermined imaging apparatus, the image processing apparatus comprising:
an acquiring mechanism that acquires:
information identifying a predetermined location within the image represented by the image data;
information concerning brightness values of the predetermined location; and
the image data; and
a correcting mechanism that corrects the gradation scale of the brightness values of the image represented by the image data using the average of the brightness values of the predetermined location identified by the acquired information as a reference value.

2. The image processing apparatus of claim 1, wherein the predetermined location comprises a region specified when the image is shot.

3. The image processing apparatus of claim 1, wherein the predetermined location comprises a region previously set in the image.

4. An image processing program that corrects a gradation scale of brightness values of an image represented by image data produced in a predetermined imaging apparatus, the program causing a computer to execute:
an acquiring function that acquires:
at least one of:
information identifying the predetermined location within the image represented by the image data; and
information concerning brightness values of the predetermined location; and
the image data; and
a correcting function that corrects the gradation scale of the brightness values of the image represented by the image data using the average of the brightness values of the predetermined location identified by the acquired information as a reference value.

5. An image processing method of correcting a gradation scale of brightness values of an image represented by image data produced in a predetermined imaging apparatus, the method comprising the steps of:
acquiring information identifying:
at least one of:
a predetermined location within the image represented by the image data; and
information concerning brightness values of the predetermined location; and
the image data; and
correcting the gradation scale of the brightness values of the image represented by the image data using an average of the brightness values of the predetermined location determined by the acquired information as a reference value.

6. An imaging apparatus that produces image data of a photographed image, comprising:
an exposure-controlling mechanism that performs exposure control so that an average of brightness values of a predetermined photometric region coincides with an exposure reference value set based on a targeted contrast ratio; and
an image data-producing mechanism that produces image data corresponding to information identifying at least one of:
the predetermined photometric region; and
the average of brightness values of the photometric region.
